(19) United States
(12) Patent Application Publication
(10) Pub. No.: US 2013/0290079 A1
(43) Pub. Date: Oct. 31, 2013

(54) SYSTEMS AND METHODS FOR INSERTION OF CONTENT INTO AN EMAIL OVER IMAP

(71) Applicant: Viraj Chavan, Sunnyvale, CA (US)

(72) Inventor: Viraj Chavan, Sunnyvale, CA (US)

(21) Appl. No.: 13/458,686

(22) Filed: Apr. 27, 2012

(51) Int. Cl. G06F 15/16; G06Q 30/02

(52) U.S. Cl. 705/14.4; 709/206

(57) ABSTRACT

A system and method to insert content into an email over IMAP are disclosed. The system and method may receive an email from a first user and store the email from the first user on a server. In some embodiments, content such as an advertisement, news, image, and/or video may be created or selected for the stored email. The content may be inserted into the email. In some embodiments, the server may transmit the stored email with the inserted content to a second user. The content may be inserted as dynamic HTML tags within an email protocol.

### FIELD

The present disclosure relates to systems and methods for transmitting emails. In some embodiments, the present disclosure relates to systems and methods for insertion of content into an email over IMAP.

### BACKGROUND

The Internet is a ubiquitous medium of communication in most parts of the world. The emergence of the Internet has opened a new forum for the creation and placement of advertisements promoting products, services, and brands. Internet content providers rely on advertising revenue to drive the production of free or low cost content. Advertisers, in turn, increasingly view Internet content portals and online publications as a critically important medium for the placement of advertisements.

The interactive nature of Internet communication enables advertisers and content providers to target advertising campaigns to viewers. Advertisers may pay for the display of an advertisement to a viewer. For example, an advertiser may pay for each advertisement impression on a web page, a user clicking on an advertisement, or for a conversion of a product or service associated with the advertisement. However, such traditional advertising models are limited to web pages.

As such, it is desirable to develop systems and methods of generating revenue based on advertising beyond merely web pages. For example, as disclosed herein, advertisements or content may be inserted into emails over Internet Access Message Protocol (IMAP). Such insertion of advertisements or content may provide an additional revenue stream in addition to conventional web page advertising.

### SUMMARY

The present disclosure introduces systems and methods for insertion of advertisements or content into an email over IMAP.

The systems or methods may receive an email from a first user for insertion of an advertisement or additional content. In some embodiments, the email comprises an identification of a plurality of portions of content of the email. The email from the first user may be stored. The additional content at least partly based on the email from the first user may be selected. The email may be modified by inserting the additional content into a selected portion of the email to create an outbound email with the inserted additional content. A request from a second user for the email may be received. The outbound email with the inserted additional content may be transmitted to the second user.

In some embodiments, the identification of the portions of content of the email comprises types of the portions of content and sizes of the portions of content of the email.

In some embodiments, the modifying of the email further comprises changing the size of the selected portion of the email based on a size of the inserted additional content.

In some embodiments, the inserted additional content comprises a first size, the selection portion of the email comprises a second size, and the email is modified such that the changing of the size of the selected portion comprises the addition of the first size to the second size.

In the same or alternative embodiments, the email is stored in an Internet Message Access Protocol (IMAP) format and the inserting of the additional content is performed over the IMAP format.

In some embodiments of the disclosure, the selected portion is HyperText Markup Language (HTML) content and the inserted additional content comprises HTML tags.

In some embodiments, the inserted additional content is inserted based on content of the email.

### BRIEF DESCRIPTION OF THE DRAWINGS

The novel features of the disclosure are set forth in the appended claims. However, for purpose of explanation, several embodiments of the disclosure are set forth in the following figures.

FIG. 1 is a flow diagram of an example method for inserting content into an email.

FIG. 2 is an example embodiment of an environment for a system and/or a method to insert content into an email over IMAP in accordance with some embodiments of the disclosure.

FIG. 3A depicts a diagram illustrating an email message in accordance with some embodiments of the present disclosure.

FIG. 3B depicts a diagram illustrating an email message with an inserted advertisement in accordance with some embodiments.

FIG. 4 is an example flow diagram illustrating an environment for receiving an email and transmitting the email with inserted content in accordance with some embodiments of the present disclosure.

FIG. 5 is a flow diagram of an example method to insert content into an email over IMAP in accordance with some embodiments.

FIG. 6 is a flow diagram of another example method to insert content into an email over IMAP in accordance with some embodiments.

FIG. 7 is an example embodiment of an online advertising system in accordance with some embodiments.

FIG. 8 depicts a diagram illustrating an advertisement delivery system within which some embodiments of the disclosure are implemented.

FIG. 9 depicts a diagram illustrating an advertisement delivery system within which some embodiments of the disclosure are implemented

FIG. 10 depicts a diagram illustrating an exemplary computing system for execution of the operations comprising various embodiments of the disclosure.

### DETAILED DESCRIPTION

The systems and methods disclosed herein relate to inserting content into an email over IMAP.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

The disclosure that follows is divided into three sections. Section I contains terms used herein. Section II describes a system and method to insert content into an email over IMAP. Section III describes an environment in which some embodiments of the present disclosure may operate.

### I. TERMS

Some of the terms used in the disclosure are defined below in alphabetical order. These terms are not rigidly restricted to these definitions. A term may be further defined by the term's use in other sections of the disclosure.

“Ad” (e.g., advertisement, item and/or message) may refer to a paid announcement, as of goods or services for sale. An ad may also be referred to as an ad, advertisement, an item and/or a message.

“Ad call” may refer to a message sent by a computer to an ad server for requesting an ad to be displayed (e.g., within an email). An “ad call” may be referred to as an “advertisement call.”

“Ad server” may refer to a server that is configured for serving one or more ads to user devices. An ad server may be controlled by a publisher of a website, email server, and/or an advertiser of online ads. A server is defined below.

“Advertiser” (e.g., messenger and/or messaging customer, etc.) may refer to an entity that is in the business of marketing a product and/or a service to users. An advertiser may include, without limitation, a seller and/or a third-party agent for the seller. An advertiser may also be referred to as a messenger and/or a messaging customer.

“Advertising” may refer to marketing a product and/or service to one or more potential consumers by using an advertisement. An example of advertising may comprise inserting or publishing an advertisement into an email message.

“Application server” may refer to a server that is configured for running one or more devices loaded on the application server.

“Click” (e.g., ad click) may refer to a selection of an ad impression by using a selection device such as, for example, a computer mouse or a touch-sensitive display on a user device (e.g., a mobile device such as a smart phone).

“Client” may refer to the client part of client-server architecture. A client may comprise a user device and/or an application that runs on a user device. A client may rely on a server to perform operations. For example, an email client is an application that enables a user to send and receive email via an email server. As such, the computer running such an email client may also be referred to as a client.

“Conversion” (e.g., ad conversion) may refer to a purchase of a product and/or service that occurs as a result of a user responding to an advertisement.

“Database” (e.g., database system, etc.) may refer to a collection of data organized in such a way that a computer program may quickly select desired pieces of the data. A database may be an electronic filing system. In some instances, the term “database” may be used as shorthand for a “database management system.” A database may be implemented as any type of data storage structure capable of providing for the retrieval and storage of a variety of data types. For example, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” may refer to hardware, software or a combination thereof. A device may sometimes be referred to as an apparatus. Examples of a device include, without limitation, a software application such as Microsoft Word™, an email application, or a database or hardware such as a laptop computer, a mobile device such as a smart phone, a server, a display, or a computer mouse and/or a hard disk.

“Impression” (e.g., ad impression) may refer to a delivery of an advertisement to a user device for viewing by a user.

“Internet Access Message Protocol” (IMAP) may refer to an Internet standard protocol for retrieving email. For example, IMAP may be used to transfer an email from a server to a client (e.g., a computer, mobile device, etc.). In some embodiments, an email may be modified by the insertion of an advertisement by modifying the email over IMAP.

“Item” may refer to an ad, which is defined above.

“Marketplace” may refer to a world of commercial activity where products and/or services are browsed, bought and/or sold, etc. A marketplace may be located over a network, such as the Internet. A marketplace may also be located in a physical environment, such as a shopping mall.

“Message” may refer to an ad, which is defined above.

“Messaging” may refer to advertising, which is defined above.

“Messenger” may refer to an advertiser, which is defined above.

“Network” may refer to a connection, between any two or more computers, that permits the transmission of data. A network may be any combination of networks including, without limitation, the Internet, a local area network, a wide area network, a wireless network, and/or a cellular network.

“Publisher” may refer to an entity that publishes, on a network, a web page having content and/or ads, etc.

“Server” may refer to a software application that provides services to other computer programs (and their users), on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Software” may refer to a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” may refer to a device or multiple coupled devices. A device is defined above.

“User” (e.g., consumer) may refer to an operator of a user device. A user may be a person who seeks to acquire a product and/or service. For example, a user may be a person who has composed an email or a person who has received an email over IMAP with an inserted advertisement. The term “user” may also refer to a user device, depending on the context.

“User device” (e.g., computer, mobile device, user computer, client and/or server, etc.) may refer to a single computer, mobile device, or a network of interacting computers. A user device may be a computer that a user may use to communicate with other devices over a network, such as the Internet. A user device may comprise a combination of a hardware system, a software operating system, and one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

### II. INSERTING CONTENT INTO AN EMAIL OVER IMAP

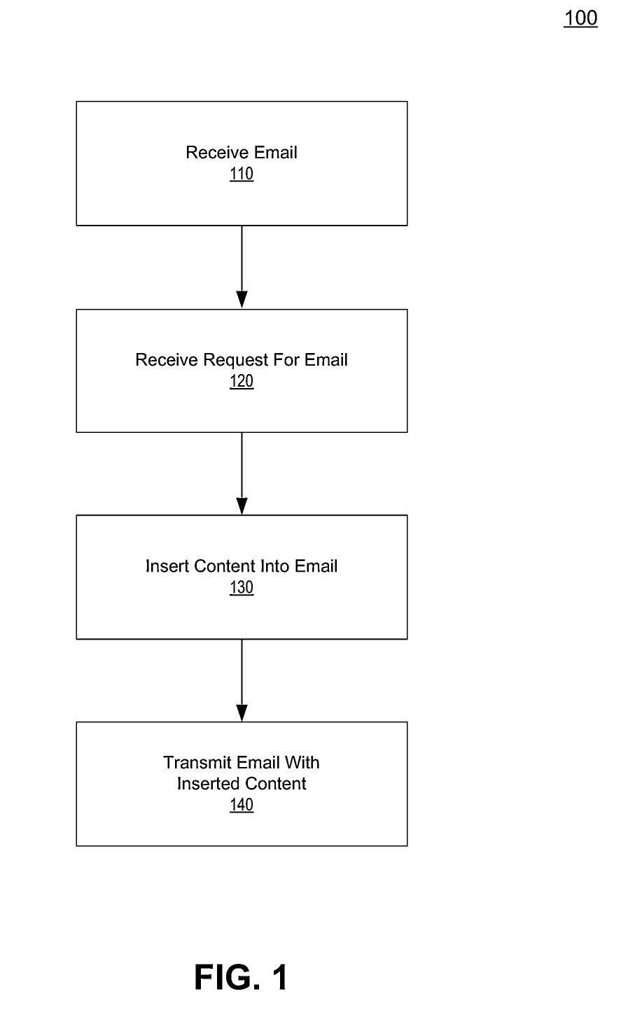

FIG. 1 is a flow diagram of a method 100 to insert content into an email. In general, content is inserted into an email over IMAP and the email with the inserted content may be transmitted to a user device requesting the email.

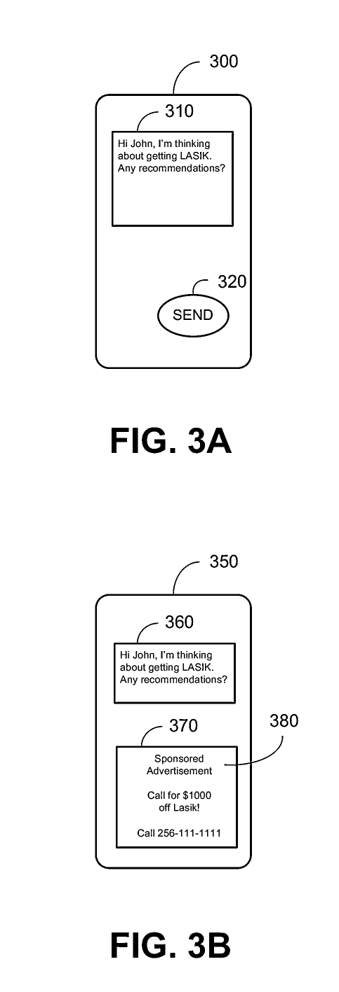

As seen in FIG. 1, at block 110, an email may be received. For example, an IMAP server may receive an email from a sending user who is transmitting an email to a recipient user. In some embodiments, the sending user is transmitting the email from a user device such as a computer or a mobile device. At block 120, a request for the email may be received. For example, the recipient user may be requesting the email from the IMAP server. In some embodiments, the recipient user may be requesting the email from a mobile device and/or a computer. The request for the email from the recipient user may be over IMAP. At block 130, content may be inserted into the email received from the sending user. For example, an IMAP server may insert content into the email. In some embodiments, the modified email with the inserted content may be stored in the IMAP server. Further details with regard to the insertion of content into an email over IMAP are disclosed with relation to FIGS. 3-6. At block 140, the email may be transmitted with the inserted content. For example, the IMAP server may store the email received from the sending user with the inserted content (e.g., the email received from the sending user has been modified to include the inserted content) and transmit the modified email to the recipient user. In some embodiments, the modified email is transmitted over IMAP. As such, content may be inserted into the email dynamically as the email is transmitted by the IMAP server.

In some embodiments, the content may comprise, but is not limited to, any or all of an advertisement, news article, image, and video. In the same or alternative embodiments, the content may be selected for insertion based on the context of the email or selected for insertion based on the user receiving the email. As such, content may be selected to be inserted into an email based on the context of the email and/or personalized for the user receiving the email.

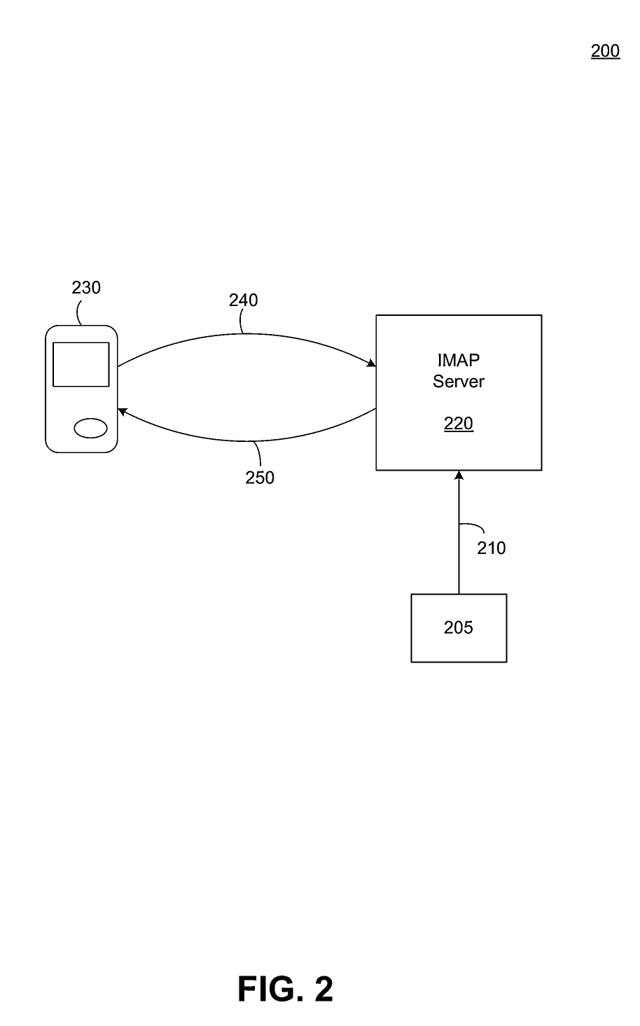

FIG. 2 is an example embodiment of an environment 200 for a system and/or a method to insert content into an email over IMAP in accordance with some embodiments of the disclosure. In general, the environment 200 comprises an IMAP server that receives an email, modifies the email by inserting content, and transmits the modified email to a user.

As seen in FIG. 2, the environment 200 may comprise a server 220. In some embodiments, the server 220 may comprise an email server (e.g., an IMAP server) that receives one or more emails from users and stores the emails to be viewed and/or transmitted to other users. The server 220 may receive an email 210 from a first user 205. In some embodiments, the first user 205 (e.g., a sending user) may use a computer and/or a smart phone (e.g., a first device). The first user 205 may compose an email message intended to be read by a second user 230. In some embodiments, email 210 from the first user 205 may be transmitted to the server 220 and the email 210 may then be modified by the server 220 and the modified version of the email (e.g., with inserted content such as an advertisement) may then be transmitted to the second user 230. In some embodiments, the second user 230 may comprise a smart phone with a native email client application. The server 220 may insert content into the email message 210 received and composed from the first user 205 and then transmit the email with the inserted content 250 to the second user 230 in response to a request 240 from the second user to view the email sent from the first user. The second user 205 may receive the email 250 over IMAP after the server 220 has inserted the content into the email message 210 from the first user 205.

As such, the environment 200 comprises a server that may insert content (e.g., an advertisement) into an email over IMAP. In some embodiments, since the server is inserting the content into an email by way of the IMAP protocol, the content may be placed into emails regardless of the type of device that users use to send and/or receive emails stored on the IMAP server.

FIG. 3A depicts a diagram illustrating an email message in accordance with some embodiments of the present disclosure. In general, an email message composition screen 300 may comprise an email message written by a first user and may not comprise an advertisement or other content inserted over IMAP.

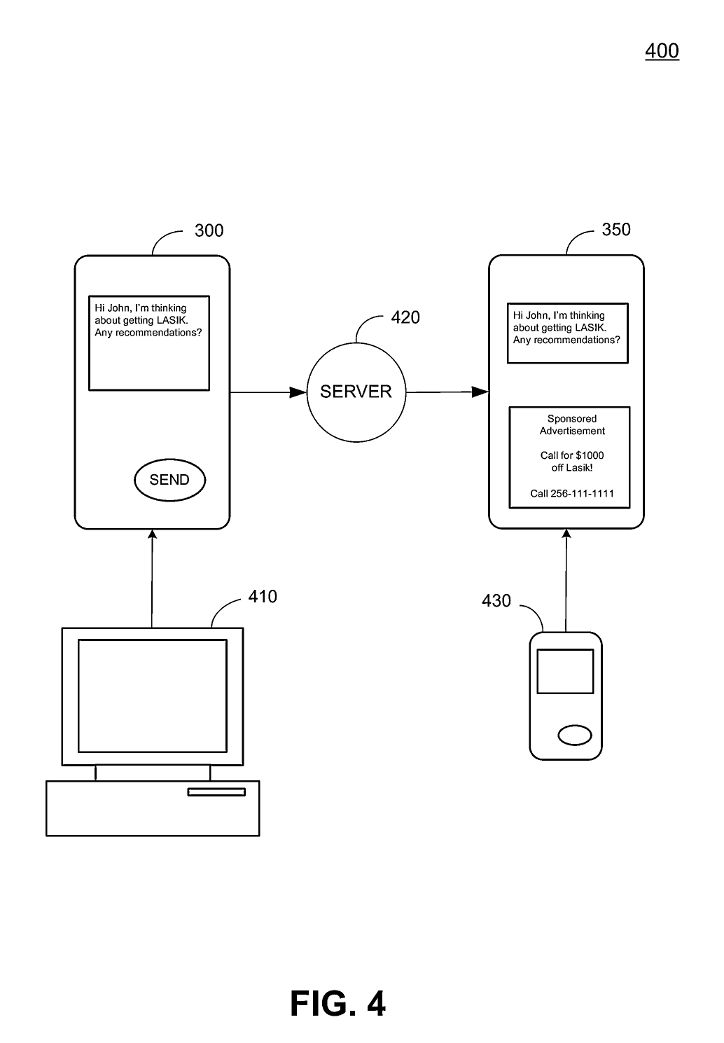

As seen in FIG. 3A, the email message composition screen 300 may comprise a written email message 310. In some embodiments, the written email message may comprise identifiable subject matter (e.g., topics) that may be used to determine content (e.g., an advertisement) to insert into the email message over IMAP as discussed with regard to FIG. 4. A user (e.g., first user 205) may compose and/or write the email message 310 to be read by another user (e.g., second user 230). The email message composition screen 300 may further comprise a send or transmit button 320 such that the user may send or transmit the email message to the other user via a server (e.g., IMAP server 220). As seen in FIG. 3, the email message composition screen 300 and/or the email message 310 do not comprise content (e.g., an advertisement) inserted into the email message over IMAP.

FIG. 3B is a diagram illustrating an email message 350 with an inserted advertisement. In general, the email message 350 may comprise a previously transmitted email (e.g., email message 310) with an advertisement inserted into the email message 310 over IMAP. Although FIGS. 3A and 3B illustrate an advertisement inserted into an email message, other types of content such as news, images, video, etc. may also be inserted into the email message.

As seen in FIG. 3B, the email message 350 may comprise email text 360. In some embodiments, the email text 360 may be written by another user (e.g., first user 205) and transmitted to a user by a server (e.g., IMAP server 220). For example, the email text 360 may comprise an email (e.g., email message 310) that has been previously transmitted to a server. A user may receive the email message 350 after requesting the email from the server. The email message 350 may comprise the email text 360 and an inserted advertisement 370. In some embodiments, the inserted advertisement 370 may comprise advertisement text 380. In the same or alternative embodiments, the inserted advertisement text 370 may comprise an advertisement that has been targeted to the user receiving the email message 350. The inserted advertisement may be targeted such that the inserted advertisement text 380 may correspond to the email text 360. For example, the inserted advertisement 370 may be selected to be inserted into the email message 350 based on the subject matter of the email text 360 and the subject matter of the inserted advertisement 370. As such, the inserted advertisement 370 may be selected to be inserted into the email message 350 based on the context of the email text 360. For example, as seen in FIG. 3B, the email text 360 may comprise a message about ‘LASIK’ procedures. As such, the inserted advertisement 370 may be selected to be inserted into the email message 350 since the inserted advertisement 370 comprises inserted advertisement text 380 concerning ‘LASIK’ procedures. Thus, the inserted advertisement 370 may be selected based on keywords of the email message 350. In some embodiments, the inserted advertisement 370 may be selected for insertion into the email message 350 at least partly based on the geographical location of a user. If a user receiving the email message 350 is in a particular geographical area, then the inserted advertisement 370 may be selected based on the user's geographical area.

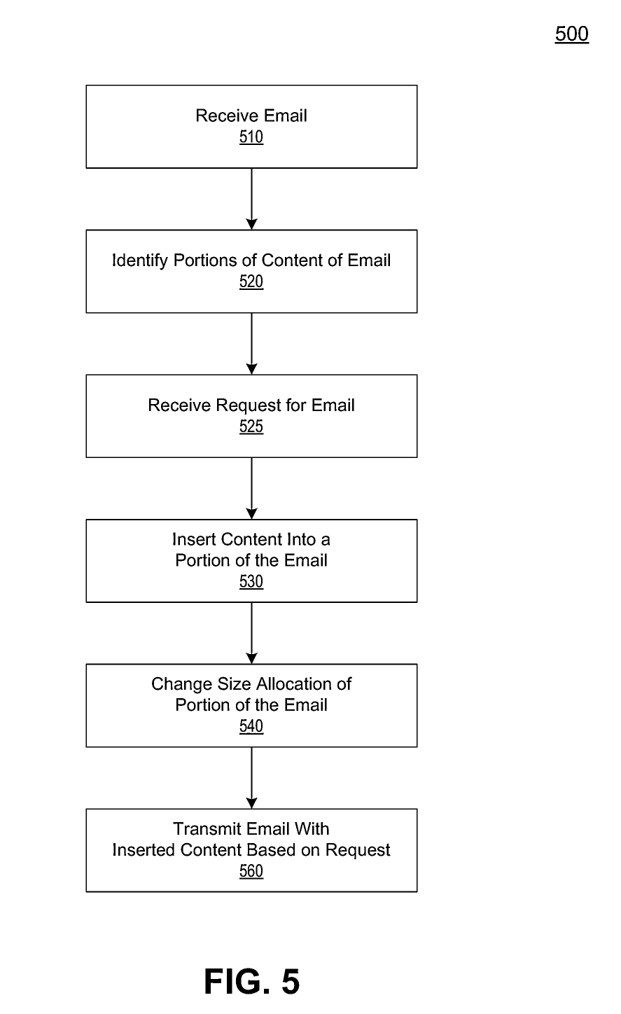

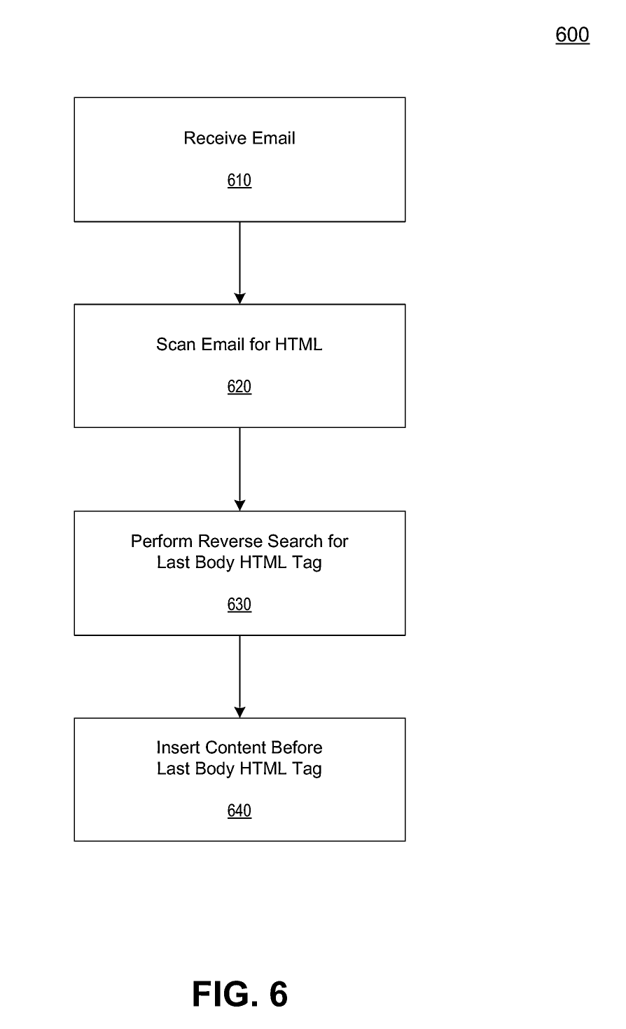

As such, the email message 350 may comprise a previously sent email from another user with an inserted advertisement. In some embodiments, the inserted advertisement may be targeted (e.g., selected to be inserted into the previously sent email) based on the context of the previously sent email and/or a geographical location of the user receiving the email. Further details with regard to inserting an advertisement into the email message are discussed with regard to FIGS. 5 and 6.

FIG. 4 is a flow diagram illustrating an environment 400 to receive an email and transmit the email with inserted content (e.g., an advertisement, news, image, video, etc.) in accordance with some embodiments of the present disclosure. In general, the environment 400 comprises a first user writing an email message (e.g., first user 205 writing written email message 310) to a second user receiving the email message with inserted content (e.g., second user 230 receiving email message 350).

As seen in FIG. 4, a first user 410 may transmit an email message 300 intended for a second user 430. The email message 300 may be received by a server 420 (e.g., IMAP server 220). In some embodiments, the server 420 may insert content such as an advertisement into the email message 300 to create the email message with an advertisement 350. The email message with the advertisement 350 may be created by inserting the advertisement as dynamic HTML tags into the protocol (e.g., IMAP) of the email message 300. Further details with regard to inserting an advertisement or other content into an email over IMAP are disclosed with relation to FIGS. 5 and 6. The user 430 may transmit a request to receive the email message with the inserted advertisement 350 from the server 420. As such, the server 420 may transmit the email message with the inserted advertisement 350 to the second user 430.

In some embodiments, the email message with the inserted advertisement 400 may be created by inserting the advertisement into the email message 300 (e.g., by the server 420). The server 420 may create the advertisement in a dynamic HTML format. For example, the advertisement may be created as dynamic HTML tags. The server 420 may insert the advertisement dynamic HTML tags into an email protocol corresponding to the email message 300. For example, the email message 300 transmitted by the first user 410 may be stored on the server 420 and may be transmitted to the second user 430 in accordance with an email protocol. For example, when the second user 430 requests the email message 300 that is stored on the server 420, the email message with the inserted advertisement 350 may be transmitted based on an Internet message access protocol (IMAP) and advertisement dynamic HTML tags may be inserted into the IMAP protocol corresponding to the email message 300. In some embodiments, the email message with the advertisement 350 may be transmitted based on another email protocol such as Post Office Protocol (POP). As such, the advertisement dynamic HTML tags may also be inserted into an email message corresponding to the POP protocol.

As such, the server 420 (e.g., an IMAP server) may receive an email from a first user and may store the email in an IMAP format. The server 420 may insert an advertisement into the IMAP protocol as dynamic HTML tags. A second user may request the email from the first user and the server may transmit the email with the advertisement (e.g., a modified version of the originally received email) to the second user who is requesting the email. Since the email message with the inserted advertisement is transmitted as an IMAP or POP based email to the second user 430, the email message with the inserted advertisement may be viewed by any device, platform, operating system, and email client application that may receive an IMAP and/or POP based email message. Thus, the insertion of the advertisement may be considered to be independent of the device and the native email application that a user may use on the device in order to read his or her emails.

FIG. 5 is a flow diagram of a method 500 to insert content into an email over IMAP in accordance with some embodiments. In general, the method 500 inserts content into a portion of a received email and modifies a size allocation for the email in the IMAP protocol.

As seen in FIG. 5, at block 510, an email may be received. For example, a server (e.g., IMAP server 230) may receive an email transmitted by a first user to a second user. The server may store the received email in an IMAP format. At block 520, portions of content of the email may be identified. For example, the email message in the IMAP format may comprise a Table of Contents (TOC) that comprises an identification for one or more types of content and a size of the content. For example, the stored email message in the IMAP format may comprise a first portion of HTML content of a size of 1 kilobyte (1000 bytes) and a second portion of text content at 200 bytes. As such, the IMAP server may scan and/or identify contents and sizes of the contents of the received email in the IMAP format from the TOC of the email. At block 525, a request for the email may be received and, at block 530, additional content may be inserted into a portion of the email. For example, the IMAP server may insert dynamic HTML tags corresponding to additional content into the HTML content of the email. In some embodiments, the additional content (e.g., the dynamic HTML tags) is inserted at the end of the identified HTML content (e.g., as identified from the TOC). At block 540, a size allocation of a portion of the email may be changed. For example, the IMAP server may insert the additional content into the HTML content of the email. As such, the IMAP server may also change the identification of the size of the HTML content from the TOC of the email to reflect the size of the inserted advertisement. For example, if the TOC identifies the HTML content portion to comprise 1 kilobyte and the additional content to be inserted by the IMAP server is 2 kilobytes, then the identification of the size of the HTML content of the TOC may be changed and/or modified from 1 kilobyte to 2 kilobytes.

In some embodiments, the request for the email may be received from a second user (e.g., a mobile device). For example, the second user may correspond to a mobile device (e.g., a smart phone) that requests the TOC information of the email stored on the IMAP server. As such, the second user may transmit a request for an identification of the portions of content of the email and the corresponding sizes of the portions of the content of the email currently stored on the IMAP server in the IMAP format. In response, the IMAP server may transmit the TOC of any emails requested by the second user. In some embodiments, the second user may then transmit a request for at least a portion of the email stored on the IMAP server. For example, the second user, after receiving and/or identifying the TOC of the email stored on the IMAP server, may request a part, segment, and/or portion of at least one of the identified portions of the email stored on the IMAP server as identified by the TOC of the email. For example, the TOC may comprise an identification of a first portion of content of the email stored on the IMAP server as being HTML with a size allocation of 3 kilobytes (e.g., 1 kilobyte corresponding to the HTML content of the email as originally received by the IMAP server from the first user and 2 kilobytes corresponding to the additional content inserted by the IMAP server). In response to receiving such an identification of the contents and corresponding size allocations, the second user may request a portion of the content of the email. For example, the second user may request to receive 200 bytes of the HTML content of the email stored on the IMAP server. In response, the IMAP server may transmit the requested 200 bytes of the HTML content of the stored email to the second user. In some embodiments, the second user may then request a further portion and/or the rest of the content from the IMAP server. In response, the IMAP server may transmit the remaining 2800 bytes (e.g., 2.8 kilobytes) where the remaining portion comprises the additional content inserted by the IMAP server. In some embodiments, if the second user requests a portion of the email that includes some, but not all, of the inserted additional content, then a white space buffer (e.g., empty space) may be transmitted to the second user instead of a partial portion of the inserted additional content. For example, if the HTML content of the email comprises 1 kilobyte of HTML content as originally sent by the first user and 2 kilobytes of the additional content (e.g., an HTML advertisement) inserted by the IMAP server, and if the second user requests 1.5 kilobytes of the HTML content as identified by the TOC of the email, then the IMAP server may transmit the 1 kilobyte corresponding to the content originally sent by the first user and 500 bytes of empty or white space as a buffer. As such, in some embodiments, the IMAP server may not transmit a portion of the inserted additional content and may only transmit the full inserted additional content to the second user. At block 560, the email (or portions of the email) with the inserted additional content may be transmitted to the second user based on the request of the second user.

As such, a first user may send an email to a second user. In some embodiments, an IMAP server may store the email from the first user. The IMAP server may store the email from the first user in an IMAP format. In some embodiments, the email in the IMAP format may comprise an identification of portion(s) of content of the email and a corresponding size allocation of the portion(s) of content of the email. The IMAP server may scan the identification of the portion(s) of content of the email for a portion to insert additional content (e.g., an advertisement, news, image, video, etc.) based on dynamic HTML tags. For example, the IMAP server may determine an HTML portion of the email sent from the first user from the identification of the portion(s) of content of the email. In some embodiments, the IMAP server may then insert dynamic HTML tags into the identified HTML portion of the email from the first user. Moreover, the IMAP server may modify the identification of the portion(s) of content of the email to reflect the addition of the inserted additional content. For example, the IMAP server may modify the size allocation corresponding to the HTML portion of the email from the first user to reflect the size of the additional content inserted via the dynamic HTML tags. As such, the IMAP server may modify the email received from the first user to generate a modified email with the inserted additional content. In some embodiments, the IMAP server may mark and/or identify stored emails that have been modified to include the inserted additional content. As a result, when a second user requests the email from the first user that is stored on the IMAP server, the IMAP server may transmit the modified email with the inserted additional content to the second user.

FIG. 6 illustrates a method 600 to insert additional content into an email over IMAP. In some embodiments, the method 600 may be used to insert additional content into an email in response to a request from a client that does not request the TOC of the email stored in an IMAP server. For example, the method 600 may be used by a user of a computer (e.g., a desktop or laptop computer) that requests the entire email stored on the IMAP server instead of requesting the TOC of the email stored on the IMAP server and requesting at least a portion of the email in response to the TOC.

As seen in FIG. 6, at block 610, an email may be received. For example, an email from a first user may be transmitted to a second user such that the email is stored on an IMAP server. At block 620, the email may be scanned for HTML content. For example, an IMAP server may scan the email for HTML content. At block 630, a reverse search of the email may be performed. For example, an IMAP server may perform a reverse search for a last or final HTML body tag in the HTML content of the email. At block 640, additional content may be inserted into the HTML content of the email. In some embodiments, the additional content may be inserted immediately before the last or final HTML body tag of the email. As such, the method 600 may be used in response to a request from a client device that does not request a TOC of an email. For example, the method 600 may be implemented in a user computer. In some embodiments, a user device may specify whether the user will request a TOC or will request an entire email. For example, a user with a computer with a broadband connection may specify that the user will want the entire email with the inserted additional content stored on the IMAP server or that a user with a mobile device may specify to receive the TOC and a portion of the email with the inserted additional content stored on the IMAP server. As such, the IMAP server may receive a notification from a user specifying how the user may request emails to be transmitted from the IMAP server to the user.

### III. ADVERTISEMENT DELIVERY SYSTEM ENVIRONMENT

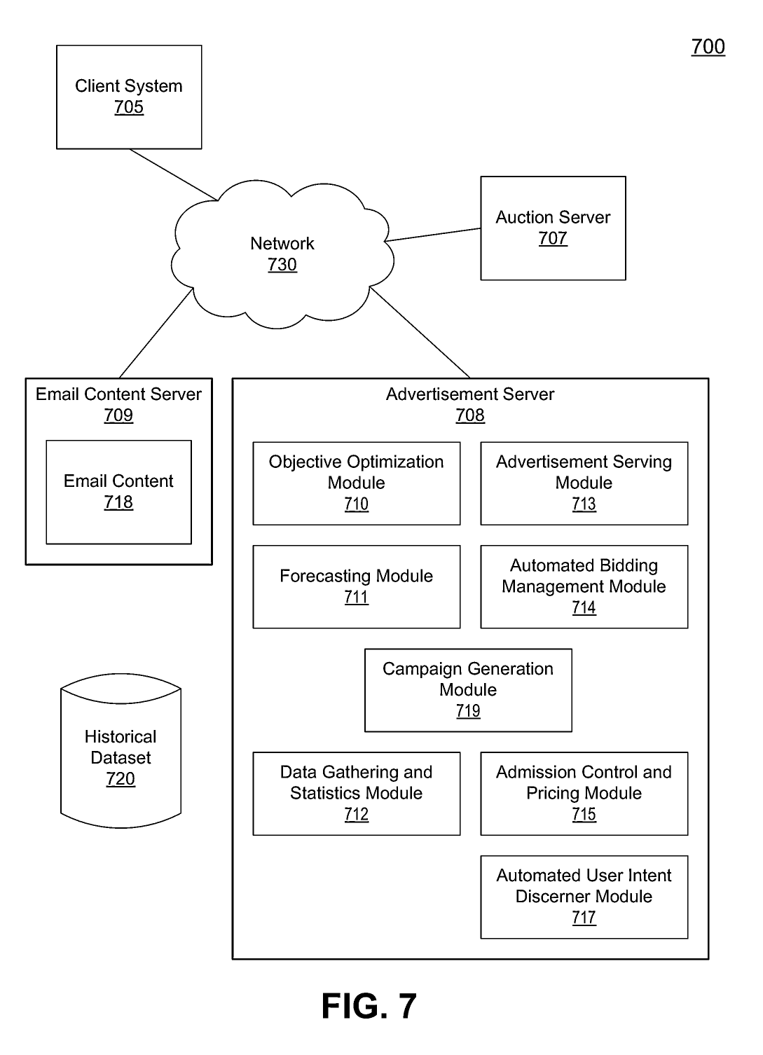

FIG. 7 is an example of an online advertising system environment 700. For example, the online advertising system environment 700 may insert content into an email over IMAP as discussed above. As such, in some embodiments, the methods 100, 500, and 600 as described with regard to FIGS. 1, 5, and 6 may be used in conjunction with the online advertising system environment 700. In the context of online (e.g., email) advertising, placement or insertion of advertisements within an email over IMAP may use the online advertising system environment 700. An internet advertiser or agent may select a particular online property (e.g., an email service), and may create an advertisement such that whenever any online user, via a client system 705 (e.g., a mobile device such as a smart phone), requests an email from the email service, the advertisement (e.g., a creative) is composited or inserted into the email message by one or more servers (e.g., a base content server 709 and/or an advertisement server 708) for delivery to a client system 705 over a network 730. Using such a delivery model and the systems and methods disclosed herein, sophisticated advertising techniques may be practiced.

As seen in FIG. 7, an online property (e.g., an email server hosting email content 718 on an email server 709) may measure the characteristics of users (e.g., where recipients of the stored emails on the email server 709 may have any arbitrary interest, demographic, target predicates, or other attributes) using an advertisement server 708 in conjunction with a data gathering and statistics module 712, and using a historical dataset 720 as pertains to user behavior that has been observed. Thus, an online user's demographics and interest might be ‘known’ in quite some detail as it pertains to a wide range of user queries, interest categories, or other demographics or attributes. Also, behaviors (e.g., the likelihood of a click or other measurable event) might be known in quite some detail, not only for a particular user, but also for a group of users corresponding to a particular subset of the available data. Such characteristics (i.e., one or more characteristics) and/or features (i.e., one or more features) can be used in statistical modeling of users. That is, a given model can predict the likelihood p of a click c based on a feature set, and thus, a given model can be used to calculate probability p(c|x), that quantity being the probability of a user click response based on the constituents of x.

Such characteristics (i.e., one or more characteristics) and/or features can be used in the statistical modeling of users, even to the extent that a forecasting module 711, possibly in conjunction with a data gathering and statistics module 712, may forecast future supply accurately of opportunities to insert advertisements into emails.

In some embodiments, the online advertising system 700 may host a variety of modules to serve management and control operations (e.g., an objective optimization module 710, a forecasting module 711, a data gathering and statistics module 712, an advertisement serving module 713, an automated bidding management module 714, an admission control and pricing module 715, etc.) pertinent to aiding advertisers in defining effective inserted advertisement campaigns and to inserted advertisements in email over IMAP to users. In particular, the modules, network links, algorithms, forecasting techniques, serving policies, and data structures embodied within the online advertising system 700 may be specialized so as to perform a particular function or group of functions reliably while observing capacity and performance requirements. For example, a campaign generation module 719 and/or an automated user intent discerner module 717 can operate partly in an offline (or batch) mode and partly in an online (or interactive) mode. Further, a database for storing the historical dataset 720 (which can also store historical click data such as use of an inserted advertisement and/or forecasted data) can operate in an online mode and/or in an offline mode. As shown, and without regard to allocation of any particular operation to any particular mode, an auction server 707 and an automated user intent discerner module 717 may be used to insert an advertisement into an email.

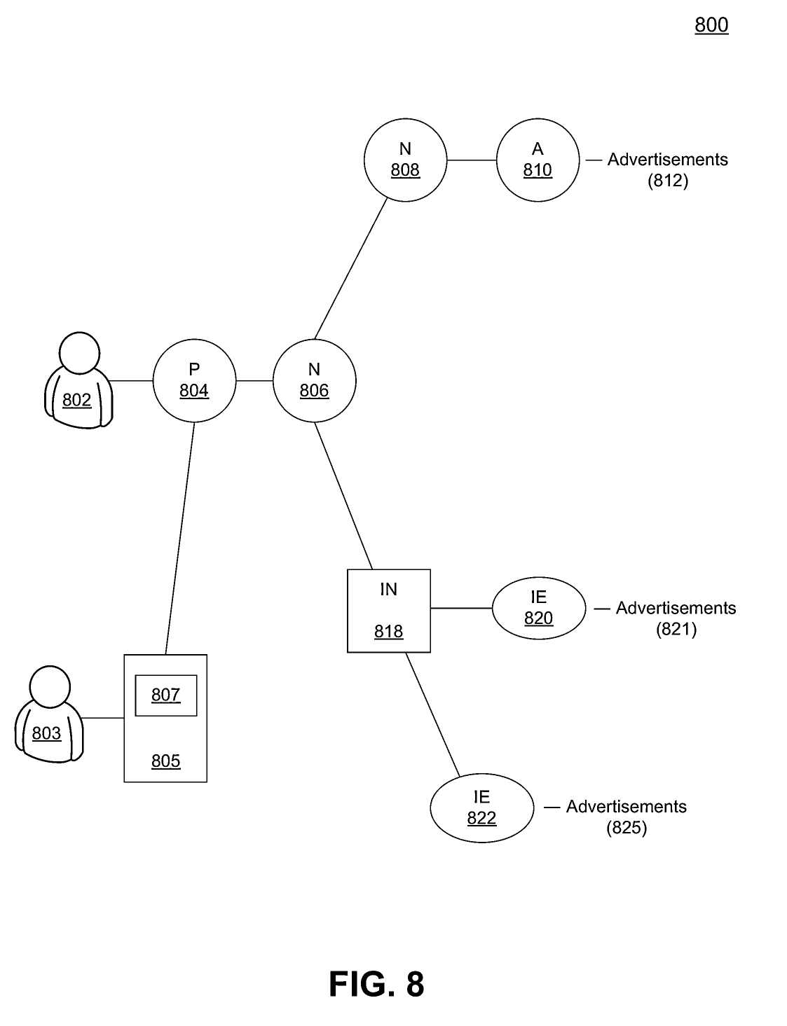

FIG. 8 illustrates an advertisement delivery system environment 800 within which some embodiments of the disclosure are implemented. In general, the embodiments described herein may be implemented as part of an advertising exchange service. An advertising exchange service may integrate entities such as advertisers and publishers (e.g., an email service). An advertising exchange service may operate in conjunction with advertisers and email service in order to deliver or insert advertisements, from one or more advertisers, to emails received by one or more users.

An integrator network entity may define a participant of the advertising exchange system that represents or integrates one or more entities on the advertising exchange system (e.g., advertisers, email service host, advertising networks, etc.). For example, an integrator network may represent advertisers on the advertising exchange system in order to deliver advertisements to email service hosts, advertising networks and other integrator networks. In some embodiments, the integrator networks are referred to as the “users” of the advertising exchange system. The integrated networks may comprise third party agents that operate on behalf of or are part of the integrator network. The term “third party agent” may be used to generally describe an agent or customer that participates in transactions on the advertising exchange system. Similarly, the term “third party recipient” may be used to describe a user or participant of the advertising exchange system that receives information from the system, such as bid requests. However, the terms integrator networks, third party agents and third party recipients may be intended to represent a broad class of entities, including email service hosts, advertisers and networks, as well as the agents that represent them, that operate on the advertising exchange system.

As shown in FIG. 8, the system 800 includes a plurality of entities end users 802 and 803, one or more email service hosts 804, networks 806 and 808, and/or advertisers 810. The advertisement delivery system 800 further includes one or more integrator networks (IN) 818 that have one or more integrated entities (IE) 820 and 822. The various entities, including users, email service hosts, networks, advertisers, integrator networks and integrated entities, illustrated in FIG. 8 are merely exemplary, and one of ordinary skill recognizes that the system 800 may include any number of entities. Moreover, the various entities are coupled together in different advantageous configurations such as, for example, the exemplary configuration as seen in FIG. 8.

The user 803 may access information and/or content provided by the email service host 804. For example, a user accessing information and/or content may comprise an email client 805 displaying an email comprising inventory location(s) 807 for the presentation of advertisement(s). In some embodiments, an advertisement call is generated that requests an advertisement, from advertisements or advertisers 812, 820 and 821, for placement with the inventory location 807. The corresponding advertisement may be delivered to email service host 804 by one or more networks. In some embodiments, the network 806 may be coupled to the email service host 804 and the network 808 may be coupled to the advertiser 810. As such, the networks 806 and 808 are coupled to each other. The advertiser 810 may have one or more advertisement campaigns such that each advertisement campaign comprises one or more advertisements 812 that the advertiser 810 wishes to place with the inventory of email service hosts such as, for example, the inventory location 807 of the email service host 804 that may be presented to the user 803 via the email client application 805.

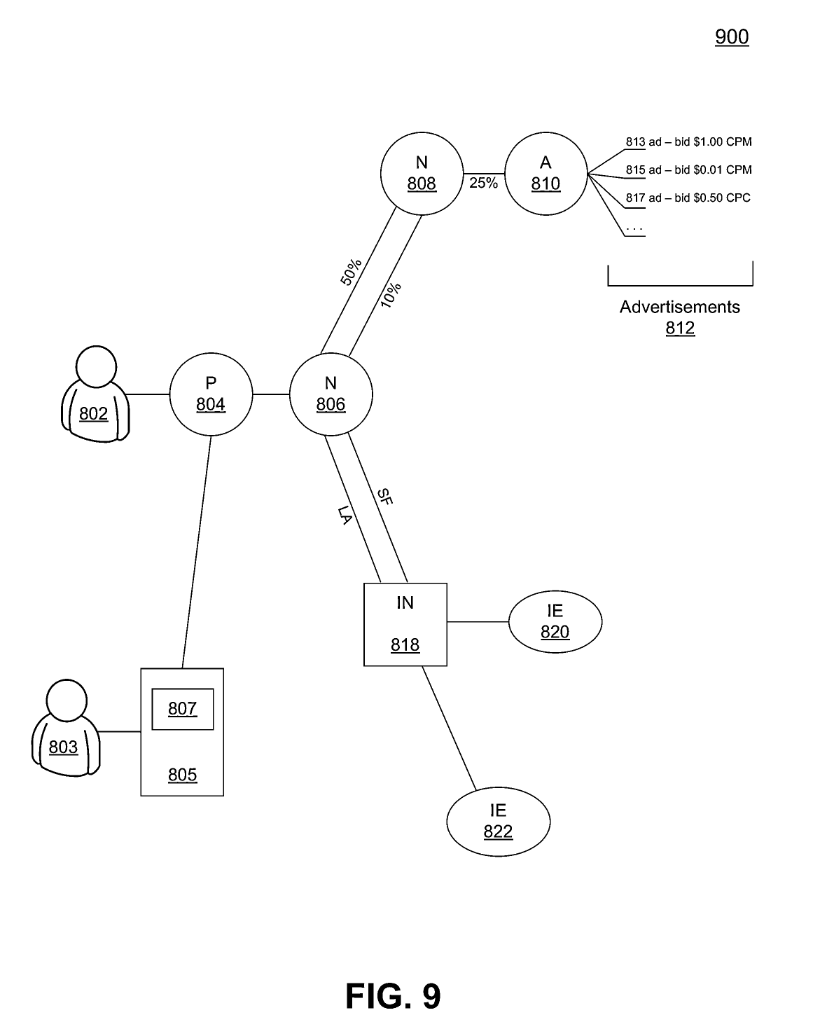

FIG. 9 is another example of an advertisement delivery system 900. In this example, the advertisements 813, 815, and 817 each may have an associated bid that the advertiser 810 will pay for the placement or insertion of the advertisement with the inventory and for presentation to the user(s). The advertisement 813 may have a bid of $1.00 cost per thousand email impressions (“CPM”), the advertisement 815 may have a bid of $0.01 CPM, and the advertisement 816 may have a bid of $0.50 cost per click (“CPC”). One of ordinary skill in the art would recognize that any different type of advertisement bid may be used in the advertisement delivery system 900. Examples of bids include, but are not limited to, CPM, CPC, and cost per action (“CPA”).

As seen in FIG. 9, the entities along the chain of distribution for the advertisements have various revenue sharing agreements. For example, the network 808 may have a 25% revenue sharing agreement with the network 806 for fees paid by the advertiser 810. Similarly, the network 806 may have 50% and 10% revenue sharing agreements with the publisher 804 for fees paid to the network 806 by way of the network 808. The multiple revenue sharing agreements between entities may be for different advertisement campaigns and/or for targeting advertisements to different segments of users (e.g., groups of users). For example, the 50% revenue sharing agreement between networks 808 and 806 may be used to target a user segment that comprises males under 40 years old who have an interest in sports. In some embodiments, the 10% revenue sharing agreement may be used to target females over 30 years old who have an interest in gardening. As such, network 808 may deliver users of the target user segment to network 806, and network 806 is the exclusive representative of the email service host 804. One of ordinary skill in the art recognizes many different payment and/or targeting schemes.

In the same or alternative embodiments, an advertisement call for the inventory 807 may be directed to an integrator network 818. For example, the advertisement call may passed from the network 806 to the integrator network 818 with additional information. In some embodiments, the additional information may comprise a geographic location for the destination of the advertisement. For example, an advertisement call may have a destination of San Francisco (SF), while a second advertisement call may have a destination of Los Angeles (LA). Based on the advertisement call and/or information, the integrator network 818 may selectively respond to advertisement calls for, or on behalf of, one or more of its integrated entities 820 and/or 822. The integrated entities 820 and 822 may include third party entities, such as advertisers, that transact on the exchange by using an intermediary, such as the integrator network 818.

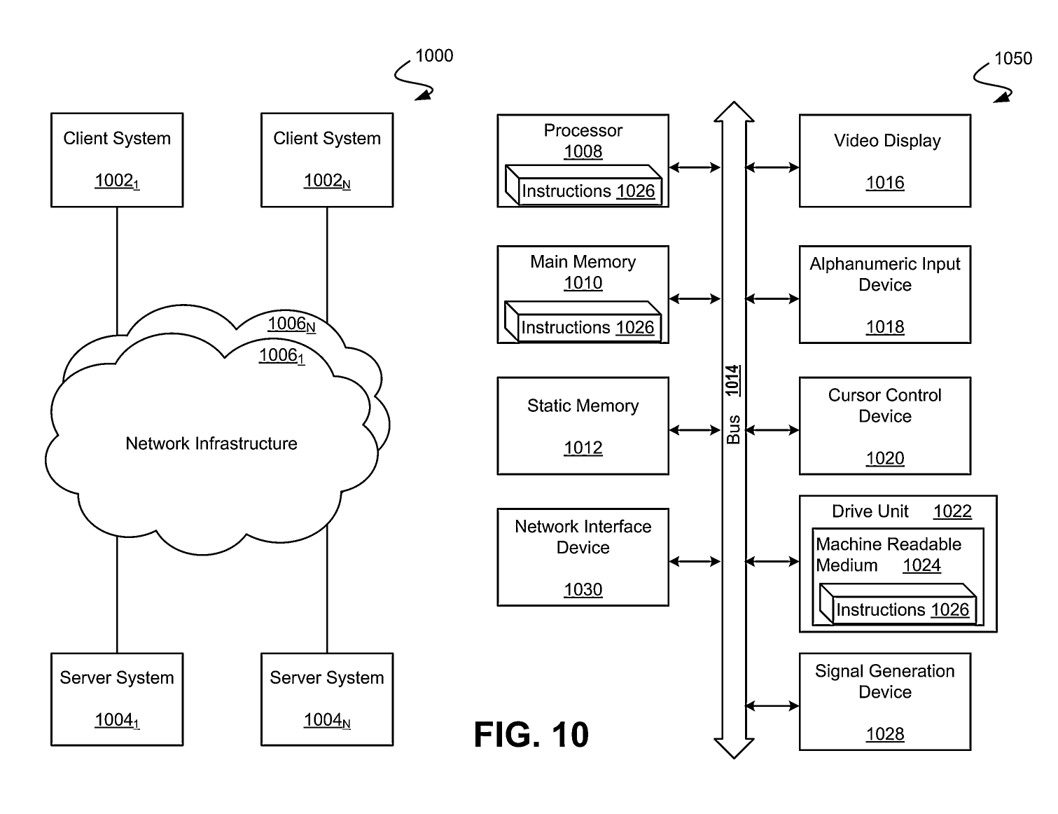

FIG. 10 is a diagrammatic representation of a network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc.), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g., a keyboard, an alphanumeric keypad, etc.), a pointing device 1020 (e.g., a mouse, a touch screen, etc.), a drive unit 1022 (e.g. a disk drive unit, a CD/DVD drive, a tangible computer readable removable media drive, an SSD storage device, etc.), a signal generation device 1028 (e.g. a speaker, an audio output, etc.), and a network interface device 1030 (e.g. an Ethernet interface, a wired network interface, a wireless network interface, a propagated signal interface, etc.).

The drive unit 1022 includes a machine-readable medium 1024 on which is stored a set of instructions (i.e. software, firmware, middleware, etc.) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

1. A method to insert additional content into an email, the method comprising:
receiving an email from a first user, the email comprising an identification of a plurality of portions of content of the email;
storing the email from the first user;
selecting, by a computer, additional content at least partly based on the email from the first user;
modifying the email by inserting the additional content into a selected portion of the email to create an outbound email with the inserted additional content;
receiving a request from a second user for the email; and
transmitting the outbound email with the inserted additional content to the second user.

2. The method of claim 1, wherein the identification of the portions of content of the email comprises types of the portions of content and sizes of the portions of content of the email.

3. The method of claim 2, wherein the modifying of the email further comprises changing the size of the selected portion of the email based on a size of the inserted additional content.

4. The method of claim 3, wherein the inserted additional content comprises a first size, the selection portion of the email comprises a second size, and the email is modified such that the changing of the size of the selected portion comprises the addition of the first size to the second size.

5. The method as set forth in claim 1, further comprising storing the email in an Internet Message Access Protocol (IMAP) format and inserting the additional content using the IMAP format.

6. The method of claim 1, wherein the selected portion comprises HyperText Markup Language (HTML) content and the inserted additional content comprises HTML tags.

7. The method of claim 1, wherein the additional content comprises an advertisement.

8. A non-transitory computer readable medium carrying one or more instructions to insert additional content into an email, wherein the one or more instructions, when executed by one or more processors, causes the one or more processors to perform the steps of:
receiving an email from a first user, the email comprising an identification of a plurality of portions of content of the email;
storing the email from the first user;
selecting additional content at least partly based on the email from the first user;
modifying the email by inserting the additional content into a selected portion of the email to create an outbound email with the inserted additional content;
receiving a request from a second user for the email; and
transmitting the outbound email with the inserted additional content to the second user.

9. The non-transitory computer readable medium of claim 8, wherein the identification of the portions of content of the email comprises types of the portions of content and sizes of the portions of content of the email.

10. The non-transitory computer readable medium of claim 9, wherein the modifying of the email further comprises changing the size of the selected portion of the email based on a size of the inserted additional content.

11. The non-transitory computer readable medium of claim 10, wherein the inserted additional content comprises a first size, the selection portion of the email comprises a second size, and the email is modified such that the changing of the size of the selected portion comprises the addition of the first size to the second size.

12. The non-transitory computer readable medium of claim 8, further comprising storing the email in an Internet Message Access Protocol (IMAP) format and inserting the additional content using the IMAP format.

13. The non-transitory computer readable medium of claim 8, wherein the selected portion comprises HyperText Markup Language (HTML) content and the inserted additional content comprises HTML tags.

14. The non-transitory computer readable medium of claim 8, wherein the additional content comprises an advertisement.

15. A system, comprising at least one processor and memory, to insert additional content into an email, the system comprising:
a module to receive an email from a first user, the email comprising an identification of a plurality of portions of content of the email;
a module to store the email from the first user;
a module to select additional content at least partly based on the email from the first user;
a module to modify the email by inserting the additional content into a selected portion of the email to create an outbound email with the inserted additional content;
a module to receive a request from a second user for the email; and
a module to transmit the outbound email with the inserted additional content to the second user.

16. The system of claim 15, wherein the identification of the portions of content of the email comprises types of the portions of content and sizes of the portions of content of the email.

17. The system of claim 16, wherein the module to modify the email further comprises the module to change the size of the selected portion of the email based on a size of the inserted additional content.

18. The system of claim 17, wherein the inserted additional content comprises a first size, the selection portion of the email comprises a second size, and the email is modified such that the changing of the size of the selected portion comprises the addition of the first size to the second size.

19. The system of claim 18, wherein the email is stored in an Internet Message Access Protocol (IMAP) format and the additional content is inserted using the IMAP format.

20. The system of claim 15, wherein the selected portion comprises HyperText Markup Language (HTML) content and the inserted additional content comprises HTML tags corresponding to an advertisement.
